(19) United States
(12) Patent Application Publication
(10) Pub. No.: US 2004/0250573 A1
(43) Pub. Date: Dec. 16, 2004

(54) Flame hydrolysis process for the manufacture of glass bodies of doped silica glass

(76) Inventors: Hrabanus Hack, Mainz (DE); Joerg Schuhmacher, Kornwestheim (DE); Matthias Schmidt, Jena (DE); Andreas Menzel, Jena (DE)

Correspondence Address: HARNESS, DICKEY & PIERCE, P.L.C., P.O. BOX 828, BLOOMFIELD HILLS, MI, 48303, US

(21) Appl. No.: 10/826,078

(22) Filed: Apr. 16, 2004

(30) Foreign Application Priority Data
Apr. 26, 2003 (DE) 103 18 935.1
Oct. 20, 2003 (DE) 103 49 648.3

(51) Int. Cl. C03B 19/06

(52) U.S. Cl. 65/17.4

(57) ABSTRACT

A process for manufacturing glass bodies of doped silicate glass is disclosed. The process involves flame hydrolysis, wherein precursors for the forming of the doped glass are fed together with fuel gases into a single burner. A first formed body is generated on a target. The doped silicate glass produced in this way offers a low density of defects and a small breadth of striae. Preferably the first formed body is subsequently formed into a second formed body having a larger breadth and a smaller length than the first formed body. Thereby, the breadth of striae and the density of defects in the doped silica glass is further reduced.

### BACKGROUND OF THE INVENTION

The invention relates to a process for the manufacture of glass bodies of doped silica glass. The invention further relates to doped silica glasses having low defects and small striae.

In the EUV lithography (extreme ultra violet) substrate materials are required for the reflecting optics and masks used therein that do not have a perceptible thermal expansion within the temperature range between 20 and 30° C. To this end so-called NZTE materials (near zero thermal expansion) have been developed. A material that fulfils these requirements is a silica glass doped with titanium oxide which is marketed by the company Corning Incorporated under the trademark ULE.

A process for the manufacture of ULE™ glass is known from U.S. Pat. No. 5,970,751. Herein the doped silica glass is molten by flame hydrolysis in a multiple-burner process wherein the burners are fed with a mixture of a silicon oxide precursor and a titanium oxide precursor in gaseous form, wherein the vapor mixture in the flames of the burner generates SiO₂ particles and TiO₂ particles which deposit within a furnace in which they are molten and form a solid glass body the shape of which is determined by the melting pot that is used. The glass body manufactured in this way which may have a diameter of 1 meter or more is designated as a “boule”. From this boule shaped bodies are cut out that, for example, are used as reflecting mirrors in the EUV lithography.

However, the boules manufactured in this way have been found to contain problematic defects that, due to the process, are integrated as bulk defects during melting of the block material and which emerge on the surface during polishing of mask and mirror blanks that are made thereof. In this regard, they bear the danger that they are not removed in the same manner as the matrix material during polishing. Thus, elevations may emerge on the substrate surface or the defect regions may be removed in total from the matrix, thus leaving recesses on the substrate surface. In this way, surface defects generated thereby act as optically dispersive centers that substantially impair the quality of the products made thereof. In particular, problems emerge during coating of the polished mask and mirror blanks that on their parts lead to a strong impairment of the imaging characteristics when using the reflective components in the EUV lithography.

In addition, the doping with such components that have a refractive index deviating more or less from quartz glass leads to the generation of striae which are detrimental for the application of the material in EUV lithography.

The striae have an average thickness of 150 micrometers which in particular leads to depressions on the surfaces of the components during the manufacture of aspherical EUV optics. These depressions must subsequently be flattened at high expense using IBF treatment (iron beam figuring).

According to WO-A-0232622, it has been suggested to avoid the impairments of the striae in this material by treating the glass during manufacture of the components in such a way that the inner striae follow the curvature of the component surfaces and thus do not protrude to the surface.

However, this manufacturing process is complicated and cannot avoid with sufficient safety that the surface characteristics are still impaired by striae or defects.

Although it is basically known that undoped silica glass can be produced by flame hydrolysis at relatively high quality (see WO-A-98/40319 or EP-B-0,861,812), these circumstances cannot be applied to the manufacture of doped silica glasses, as can be seen from U.S. Pat. No. 5,154,744. Namely, during the manufacture of silica glasses doped with titanium oxide, a manufacture by flame hydrolysis is directly followed by a heating step under a helium/chlorine atmosphere to reach a full consolidation of the shaped bodies manufactured thereby, before these are drawn to fibers.

### SUMMARY OF THE INVENTION

Thus, it is a first object of the invention to disclose an improved process for the manufacture of glass bodies of doped silica glass leading to a high quality of the silica glass product.

It is a second object of the invention to disclose an improved process for the manufacture of glass bodies of doped silica glass leading to less defects in the glass body than can be reached with prior manufacturing processes.

It is a third object of the invention to disclose an improved process for the manufacture of glass bodies of doped silica glass leading to small striae thicknesses.

It is a further object of the invention to disclose a doped silica glass product that is particularly suited as a substrate material for the manufacture of reflective optics and masks in the EUV lithography.

These and other objects of the invention are solved by a process for the manufacture of glass bodies of doped silica glass by flame hydrolysis, wherein a first shaped body is formed on a target by means of a single burner into which fuel and precursors for the generation of the glass are fed.

The object of the invention is solved completely in this way.

By manufacturing the shaped body by means of a single burner, it is ensured that no disturbing interactions can emerge between two or more burners, as always being the case when utilizing a multiple-burner system. The possibility of a clean, undisturbed flow around the cap of the rod emerging during this process is considerably enhanced.

In this way, a manufacture of doped silica glasses having considerably less and smaller defects is made possible. Within the silica glass body considerably less defects are found than in boules manufactured using multiple burners. Foreign particles, e.g. detachments from the furnace wall material, during melting cannot reach the cap of the shaped body and thus are not included in the material. By contrast, they are passed out of the furnace together with the burner exhaust gases. This leads to a considerably smaller defect density when compared with prior art titania doped silica glass, such as according to U.S. Pat. No. 5,970,751.

Simultaneously, also smaller striae are produced when compared with the multiple-burner process according to U.S. Pat. No. 5,970,751.

The single-burner process according to the invention offers the advantage that only a single main flow is generated within the melting zone.

According to a preferred development of the invention, the shaped body is subsequently reshaped into a second shaped body having a larger breadth and a smaller height than the first shaped body.

Herein in the first step a first shaped body is generated, this being a long, thin shaped body. This first, long shaped body (also called rod) is reshaped by sagging into a second shaped body, the shape and size of which may correspond to the desired geometry of the component to be produced or maybe similar thereto.

Due to the resagging, the striae thickness is reduced by the flow factor of the sagging operation. In this way a striae thickness of ≦70 μm can be reached without any problem. Also, striae thicknesses of ≦10 μm are possible. A further reduction of the striae thickness can be reached by further resagging steps, in case necessary according to the particular application.

The dopant may preferably be TiO₂. However, the invention can advantageously be also used in the manufacture of silica glass doped with any dopant, e.g. when the glass body is formed with a dopant comprising fluorine, germanium, vanadium, chromium, aluminum, zirconium, iron, zinc, tin, tantalum, boron, phosphorus, niobium, lead, hafnium, molybdenum or tungsten. Herein the dopants lead to a relatively strong deviation in the refractive index of the silica glass.

Preferably, the doping comprises at least 0.1 weight percent, preferably at least about 0.5 weight percent and normally lies in the percent range with most dopants. However, if fluorine is used as a dopant, the range is lower with at least about 50 wt.-ppm, normally, a few hundreds wt.-ppm.

According to a preferred development of the invention, the target is driven rotatingly during the manufacture of the first shaped body.

In addition, herein preferably the distance between the shaped body and the burner, i.e. the distance between the cap of the shaped body and the burner, is kept substantially constant during manufacture.

These measures serve to generate a shaped body as homogeneous as possible and having little defects.

Preferably, the precursors are fed to the burner in gaseous form.

According to a preferred development of the invention a disk is utilized as a target which may consist of silica glass or another suitable material. Also, a flange disk e.g. consisting of silica glass or preferably of doped silica glass can be utilized as a target.

The target may be arranged substantially horizontally and the first shaped body may grow substantially in vertical direction. Alternatively, it is also possible to arrange the target substantially vertically and to grow the first shaped body substantially in horizontal direction onto the target.

As mentioned before, the silica glass doped with TiO₂ produced according to the invention is particularly suitable for the manufacture of an EUVL substrate material.

Particularly positive results with low striae thickness can be reached when performing further resagging steps.

An EUVL component can be produced from such a formed body by fine machining to a desired shape, size and surface characteristic.

It shall be understood that the features of the invention mentioned before and to be described hereinafter cannot only be used in the given combination but also in different combinations or on their own, without going beyond the scope of the invention.

### BRIEF DESCRIPTION OF THE DRAWINGS

Further features and advantages of the invention will be understood from the following description of preferred embodiments with reference to the drawings. In the drawings show:

FIG. 1 a schematic representation of a device according to the invention for producing a first shaped body by flame hydrolysis;

FIG. 2 a schematic representation of the resagging process for producing a second shaped body having a larger diameter and a smaller height;

FIGS. 3a,b striae plots before and after resagging of silica glass doped with TiO₂;

FIG. 4a a defect plot of a 6″ mask blank substrate obtained from a prior art titanium doped quartz glass produced by the multiple-burner process according to U.S. Pat. No. 5,979,751; and

FIG. 4b a defect plot of a 6″ mask blank substrate of a titanium doped silica glass according to the invention.

### DETAILED DESCRIPTION OF THE PREFERRED EMBODIMENTS

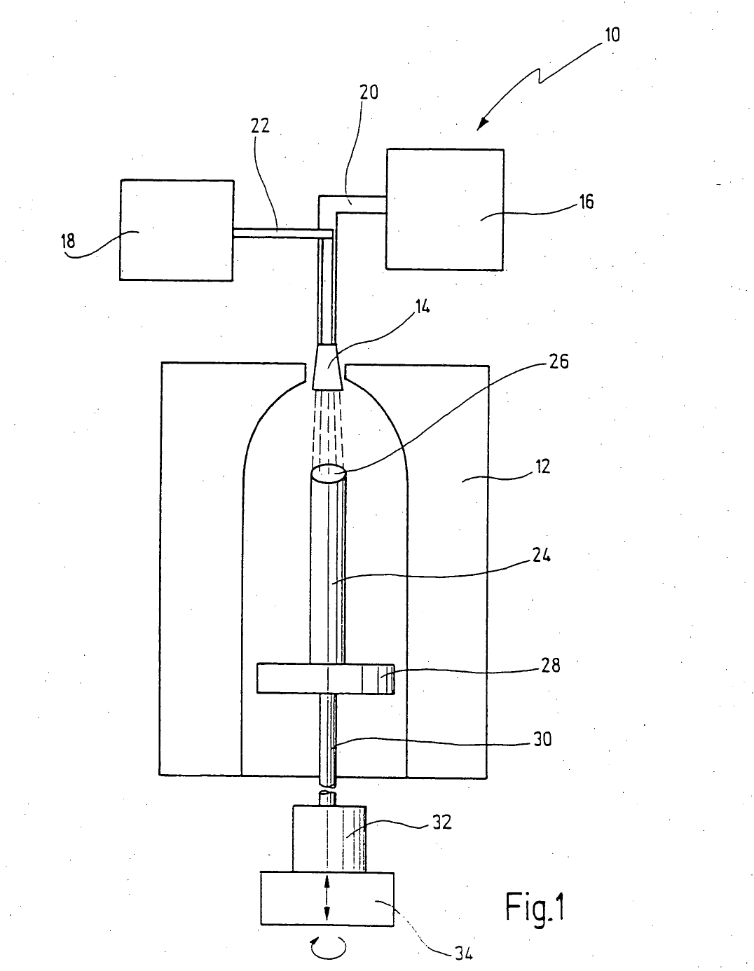

In FIG. 1 a device for the manufacture of a first shaped body 24 by flame hydrolysis is depicted schematically and designed in total with numeral 10.

The device 10 comprises a first furnace muffle 12 at the bottom of which a target 28 is provided for growing a first shaped body 24 thereon. The target 28 can be driven rotatingly by means of a motor 32 arranged outside the furnace muffle 12 via a drive shaft 30. Herein, in addition a servo-drive 34 is provided by means of which the target 28 can be adjusted in axial direction such as indicated by the double arrow. A burner 14 protrudes into the cavity of the furnace muffle through an opening in the top of the furnace muffle 12. The burner via a pipe 20 is coupled to a suitable fuel supply, such as e.g. a H₂/O₂ gaseous fuel dosing system. In addition, a pipe 22 for feeding gaseous precursors is attached to the burner 14 for producing TiO₂ doped silica glass. E.g. in the case of doping with TiO₂ the precursors may e.g. be SiCl₄ and TiCl₄ which are fed into the burner flame in gaseous form. In the high temperature of the burner flame (>2000° C.) the chlorides are decomposed and generate SiO₂ and TiO₂, so that TiO₂ doped silica glass deposits on the target 28.

For cationic dopants e.g. the following chlorine containing compounds may be used:

| | | | |
|---|---|---|---|
| Ti | TiCl₄ | Cr | CrO₂Cl₂ |
| Zr | ZrCl₄ | Mo | MoCl₅, MoCl₄, |
| | | | MoO₂Cl₂ |
| Hf | HfCl₄ | W | WCl₅, WOCl₄, |
| | | | WO₂Cl₂ |
| V | VCl₄, VOCl₃ | B | BCl₃ |
| Fe | FeCl₃ | Al | AlCl₃ |
| Nb | NbCl₅ | Ge | GeCl₄ |
| Ta | TaCl₅ | Sn | SnCl₄ |
| P | PC1₃, PCl₅, | | |
| | POCl₃ | | |

When doping with fluorine, the following gases may be used: SiF₄, CF₄, C₂F₆, and NF₃.

All elements may also be added as metallo-organic compounds, i.e. alkyl, RnE or alkoxy compounds E(OR)ₙ or mixtures thereof, respectively, such as RnE(OR)ₘ₋ₙ may be utilized as chlorine free precursors.

During flame hydrolysis, the distance between the first shaped body 24 and the burner 14 is kept constant by moving the servo-drive 34. In addition, the target 28 is driven rotatingly during flame hydrolysis. Possibly also the burner may in addition be driven in lateral direction.

During the course of production, in this way a long, thin shaped body 24 (also called rod) is grown on the target 28 gradually. Since the distance between the end (designated as cap) facing the burner 14 is kept constant, during the total process steady conditions result. Since in addition only a single burner is used, no turbulences can emerge as always possible with prior art multiple-burner processes.

According to the single-burner process according to the invention, only a single mainstream is generated within the region of the melting zone.

Preferably, the disclosed process uses annular gap burners mixing on the outside. The amount of annular jets that are arranged around a central raw material jet depends on the necessary power for the desired melting process.

To reach an optimum melting process, a homogeneous streaming around the melting zone (cap) without turbulences is necessary.

Appropriately, to this end suitable burner gas settings and suitable system design settings may be used.

The design features include burner hole geometry and the inner shape of the muffle within the region of the cap. The technical process settings of the burner gases should be selected so that by using volume rates depending on the gap geometry of the burner flow velocities are reached that become smaller from the interior to the outside. This facilitates a closed flame picture and ensures that the product particles emerging in the center can reach the melting zone undisturbed by the gas flow.

A further parameter is the shape of the cap that is generated. It should be gradual and approximately ball-shaped. The burner settings and moving paths should be selected such that no extreme recesses are generated in the center. The burner should preferably have a constant distance to the particle generation point, the distance being between 150 and 250 millimeters, preferably 200 millimeters.

The design of the furnace inner cavity (burner hole and muffle inner shape) should preferably fulfill the following criteria: The burner hole should be designed gradually conically shaped and opening gradually with an angle of 10 to 20°, preferably 13°, so that the flame outer rim keeps a distance of about 10 to 20 millimeters to the refractory material of the muffle. With respect to the muffle inner shape, it can be said that the distance of the cap should be 20 to 60 millimeters, preferably 30 millimeters. The shape should be selected such that there are no sharp edges and that the desired cap geometry is substantially copied.

The measures mentioned above guarantee a constant particle film of 1 to 2 millimeters thickness on top of the reactive melting zone of the cap and thus serve to impede the introduction of defects (foreign particles and glass soot particles) into the melt.

As a target 28, a disk consisting of a suitable material, such as silica glass or doped silica glass may be used.

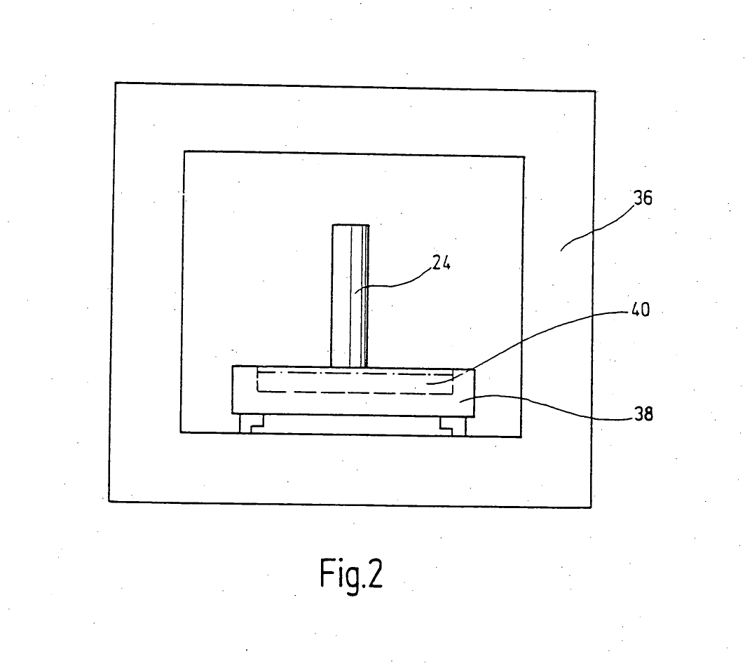

The first shaped bodies 24 produced in this way are preferably reshaped subsequently within a suitable form, such as a graphite mold 38 under protective gas using gravity assistance, the shape of the second formed bodies being approximated to the shape of the desired final products (see FIG. 2). The resagging process may be performed as so-called “pressure-assisted sagging”, in the course of which the first shaped bodies 24 are loaded by a weight of e.g. 10 kilograms.

As shown in FIG. 2, the resagging process may be performed in an electrically heated furnace 26 as known in the art using temperatures in the range of about 1600° C.

Any contact of the material with the graphite mold 38 occurring during resagging can be disregarded, since such a contact will only occur within the outer region.

Any potential defects generated in this way can by no means be compared with the defects emerging during the manufacture of boules during the prior-art multiple-burner process at the high temperatures of the flame hydrolysis when growing the first shaped bodies.

Any residual striae within the first shaped body 24 are considerably reduced by the flow-factor during resagging. For instance, striae thicknesses of 30 to 50 micrometers within the first shaped body 24 are reduced by the resagging process to striae distances of up to 10 micrometers or even below that.

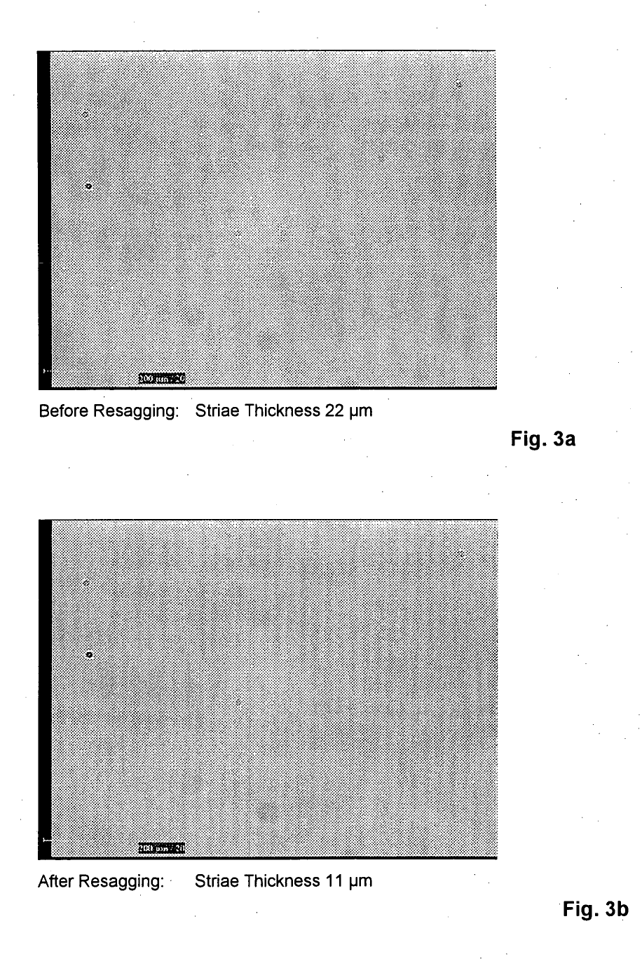

The considerable reduction of the striae thickness by the resagging process is demonstrated by FIGS. 3a and 3b which show doped silica glass having a doping of about 6.8 weight percent TiO₂.

The shape of the mold 38 for the resagging process can be approximated to the final shape of the desired product, so that only a finishing treatment substantially by grinding and polishing is necessary, e.g. to manufacture a mirror for the EUV lithography.

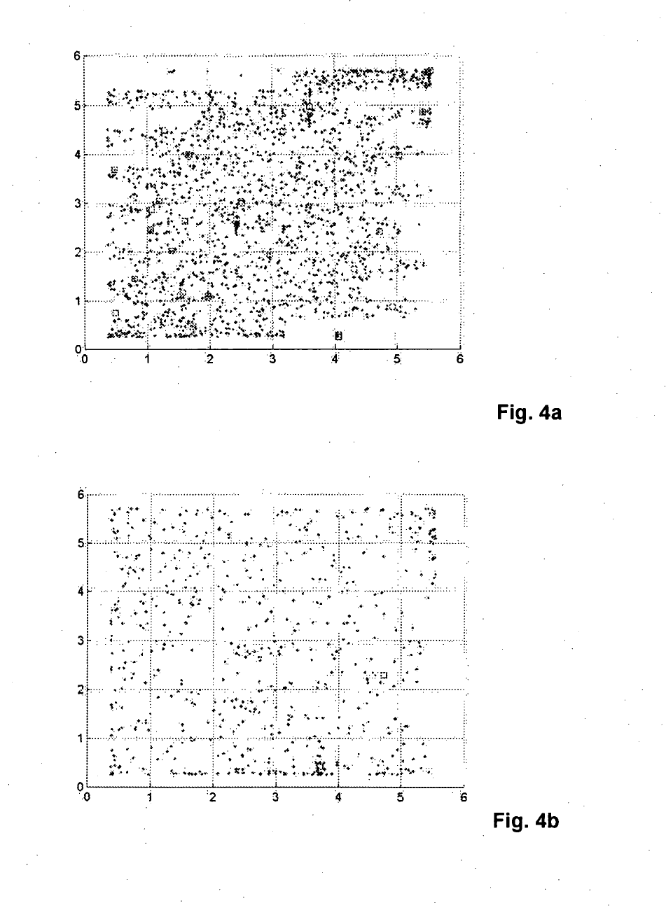

FIG. 4 depicts defect maps obtained by laser scanning of 6″ mask blank substrates produced of titanium doped silica glass produced (a) according to the multiple-burner process (ULE™) and (b) produced according to the single-burner process according to the invention, after polishing using a common polishing agent for photo masks consisting of silica glass. In both cases the concentration of TiO₂ was about 6.8 weight percent, as also the case in FIGS. 3a and 3b, respectively.

Herein the detection limit for defects was about 200 nanometers. Accordingly, the material produced by the single-burner process leads to considerably less defects when compared with glass molten by the multiple-burner process.

In particular, in the case of the prior-art ULE mask substrate very large defects (size of 2 to 11 micrometers) can be seen which are not found on the material according to the invention. Such a defect generation according to the prior-art cannot be tolerated with respect to components used as substrates for EUV masks.

What is claimed is:

1. A flame hydrolysis process for the manufacture of glass bodies of doped silica glass, wherein a first formed glass body is generated on a target by flame hydrolysis using a single burner into which fuel and precursors are fed for generating the doped silica glass, wherein a dopant is used that comprises at least one component selected from the group formed by titanium, fluorine, germanium, vanadium, chromium, aluminum, zirconium, iron, zinc, tantalum, boron, phosphorus, niobium, lead, hafnium, molybdenum and tungsten, and wherein said first formed glass body is subsequently reheated in a mold to a temperature above the glass transition temperature for reshaping the first formed glass body into a second formed body having a larger breadth and a smaller height than said first formed glass body.

2. A flame hydrolysis process for the manufacture of glass bodies of doped silica glass, wherein a first formed glass body is formed on a target by flame hydrolysis using a single burner into which fuel and precursors are fed for generating the doped silica glass.

3. The process of claim 2, wherein a dopant is used that comprises at least one component selected from the group formed by titanium, fluorine, germanium, vanadium, chromium, aluminum, zirconium, iron, zinc, tantalum, boron, phosphorus, niobium, lead, hafnium, molybdenum and tungsten.

4. The process of claim 2, wherein said first formed glass body is subsequently reheated in a mold to a temperature above the glass transition temperature for reshaping the first formed glass body into a second formed body having a larger breadth and a smaller height than said first formed glass body.

5. The process of claim 2, wherein said precursors fed into said burner are selected to yield a dopant concentration in said first formed glass body of at least 0.1 wt.-%.

6. The process of claim 2, wherein said precursors fed into said burner are selected to yield a dopant concentration in said first formed glass body of at least 0.5 wt.-%.

7. The process of claim 1, wherein said precursors fed into said burner are selected to yield a dopant concentration in said first formed glass body of at least 1 wt.-%.

8. The process of claim 1, wherein said dopant comprises at least 0.005 wt.-% of fluorine.

9. The process of claim 1, wherein said dopant comprises at least 0.01 wt.-% of fluorine.

10. The process of claim 1, wherein said target is rotatably driven while said first formed glass body is formed.

11. The process of claim 10, wherein there is a distance between said first formed glass body and said burner that is kept substantially constant during generation of said first formed glass body.

12. The process of claim 10, wherein said target is arranged substantially horizontally and said first formed glass body is grown substantially in a vertical direction.

13. The process of claim 10, wherein said target is arranged substantially vertically and said first formed glass body is grown substantially in a horizontal direction.

14. The process of claim 2, wherein a disk comprising silica glass is used as the target.

15. The process of claim 1, wherein a disk comprising doped silica glass is used as the target.

16. The process of claim 1, wherein said reshaping step is followed by at least one further reshaping step.

17. A glass body of doped silica glass comprising striae having thicknesses of # 70 micrometers.

18. The glass body of claim 17, wherein said striae have thicknesses of # 40 micrometers.

19. The glass body of claim 17, wherein said striae have thicknesses of # 20 micrometers.

20. The glass body of claim 17, wherein said striae have thicknesses of # 15 micrometers.

21. A glass body of doped silica glass comprising defects, said defects having a defect density of no more than 50 defects per square centimeter, with a given defect detection sensitivity for defects of at least 200 nanometers diameter.

22. The glass body of claim 21, wherein the defect density is no more than 25 defects per square centimeter.

23. The glass body of claim 21, wherein the defect density is no more than 10 defects per square centimeter.

24. The glass body of claim 19, further comprising defects, said defects having a defect density of no more than 25 defects per square centimeter, with a given defect detection sensitivity for defects of at least 200 nanometers diameter.

25. An EUV lithography component comprising a glass body according to claim 24.
